(19) United States
(12) Patent Application Publication
(10) Pub. No.: US 2017/0142187 A1
(43) Pub. Date: May 18, 2017

(54) Method for Uploading All of In-Vehicle Data to the Cloud in an Efficient, Automated, Secure, and Reliable Fashion

(71) Applicant: Juan R. Pimentel, Waterford, MI (US)

(72) Inventor: Juan R. Pimentel, Waterford, MI (US)

(21) Appl. No.: 15/296,825

(22) Filed: Oct. 18, 2016

Related U.S. Application Data
(60) Provisional application No. 62/243,103, filed on Oct. 18, 2015.

(51) Int. Cl. H04L 29/08; H04L 12/40

(52) U.S. Cl. CPC H04L 67/06; H04L 67/04; H04L 12/40; H04L 67/12; H04L 67/2828; H04L 67/14; H04L 2012/4026

(57) ABSTRACT

The expanding use of computing and communication technologies in vehicles for applications such as intelligent transportation and mobility increasingly requires using the cloud to store in-vehicle data. The invention details a method to upload all of the in-vehicle data to the cloud in a way that it is independent of the format of such data and of the in-vehicle communication networks used to collect such data so that sophisticated data analytics can be performed on the cloud based data for a wide variety of purposes. In addition, the invention enables uploading the in-vehicle data in a reliable fashion, efficiently by compressing the raw data before uploading it, and in a secure and confidential manner thus protecting the identity of the driver, vehicle, and manufacturer as well as the data contents. The method can be totally automated to operate in an un-attended fashion.

### CROSS-REFERENCE TO RELATED APPLICATIONS

This application claims the benefit of U.S. provisional Application No. 62/243,103 filed Oct. 18, 2015 the disclosure of which is incorporated in its entirety by reference herein.

### OTHER PUBLICATIONS

Vaishnavi Suresh and Nirmalrani V. Android based vehicle diagnostics and early fault estimation system, 2014 International Conference on Computation of Power, Energy, Information and Communication (ICCPEIC), 16-17 Apr. 2014.
Mario Gerla, Eun-Kyu Lee, Giovanni Pau, and Uichin Lee, Internet of Vehicles: From Intelligent Grid to
Autonomous Cars and Vehicular Clouds, 2014 IEEE World Forum on Internet of Things (WF-IoT), 6-8 Mar. 2014.
Yujing Wu, Jin-Gyun Chung, and Yinan Xu, CAN Data Reduction Using Three Segment Signal Decomposition,” International SoC Design Conference (ISOCC), pp. 220-221, November 2014.

### FIELD OF THE INVENTION

This invention relates to a method of uploading in-vehicle data to the cloud and particularly to reading the data to be uploaded from a real-time data logger by means of several wireless or wired communication protocols.

### BACKGROUND OF THE INVENTION

The expanding use of computing and communication technologies in vehicles for applications such as intelligent transportation and mobility increasingly involves using the cloud to store in-vehicle data. There is a huge amount of data originating from various communication, data, and control networks that are deployed inside the vehicle. The type and nature of these in-vehicle networks vary considerably and it cannot be assumed that a particular type of network is present in a certain vehicle. The data collected by the various networks may come from a wide different type of sensors or be sent to a various actuators or electronic control units. It cannot be assumed that the data collected follow a certain format of data arrangement.

In the paper entitled “Android based vehicle diagnostics and early fault estimation system”, 2014 International Conference on Computation of Power, Energy, Information and Communication (ICCPEIC), 16-17 Apr. 2014, by Vaishnavi Suresh and Nirmalrani V., it has been proposed the upload of vehicle diagnostic data to the cloud. But vehicle diagnostic data is just one type of specialized vehicle data that can be uploaded to the cloud. In addition to vehicle diagnostics, there are many other types of in-vehicle data that can be uploaded to the cloud.

Two communication links would be required, a first link between the upload engine and the real-time data logger and a second link between the upload engine and the cloud.

One of the main problems for uploading all of the in-vehicle data to the cloud is the huge size of the data that can be in the order of tens of Giga bytes per day. Furthermore, even if efficient and automated methods for uploading in-vehicle data to the cloud were available, stakeholders are concerned about the security of such data, particularly the possibility of sensitive or confidential data ending up in the wrong hands. An additional problem is that because of the mobile nature of vehicles the wireless communication links between the vehicle and the cloud may be lost making the communication task extremely un-reliable.

The expected progression in the digitalization of vehicles into areas such as automated driving and mobility would benefit from having near real-time in-vehicle data available at the cloud. It is thus desirable to have a method for uploading data to the cloud that is generic in nature, totally automated, efficient, secure, and reliable. Multiple benefits can be achieved with such an system. For example, tracking performance data available at the cloud can help vehicle manufacturers design more reliable products and discover other ways to serve customers.

### SUMMARY OF THE INVENTION

It is therefore an object of the invention to upload all of the in-vehicle data to the cloud in a way that it is independent of the format of such data and of the in-vehicle communication networks used to collect such data so that sophisticated data analytics can be performed on the cloud based data for a wide variety of purposes. Another object of the invention is to perform the in-vehicle data upload in a reliable fashion that would enable a vehicle to upload the data even when the vehicle is in movement or loose wireless communications with the cloud. A further object of the invention is to upload the data efficiently by compressing the raw data before uploading it. Still another object of the invention is to perform the in-vehicle data upload in a secure and confidential manner thus protecting the identity of the driver, vehicle, and manufacturer as well as the contents of the data. A final object of the invention is to perform the upload to the cloud in a totally automated or un-attended fashion.

The need for a process to upload in-vehicle data to the cloud has been recognized in several publications such as in the paper “Internet of Vehicles: From Intelligent Grid to Autonomous Cars and Vehicular Clouds,” 2014 IEEE World Forum on Internet of Things (WF-IoT), 6-8 Mar. 2014, by Mario Gerla, Eun-Kyu Lee, Giovanni Pau, and Uichin Lee. But it is not trivial to have a process to upload in-vehicle data to the cloud in a manner that is generic in nature, totally automated, efficient, secure, and reliable and this invention details such process. Uploading all of the in-vehicle data with the aforementioned properties would work on a wide variety of vehicles that use an in-vehicle communication protocol and would help emerging applications such as the Internet of autonomous vehicles.

### BRIEF DESCRIPTION OF THE DRAWINGS

The method described above including the advantages of the invention will become more apparent from the following description together with the accompanying drawings wherein like references refer to like parts and wherein:

FIG. 1 is a schematic diagram of the main components of the system for uploading all of in-vehicle data to the cloud in an efficient, automated, secure, and reliable fashion.

FIG. 2 is a diagram of one embodiment of the upload protocol engine.

FIG. 3 is a flowchart of a classification and compression engine for the case where the in-vehicle data comes from a CAN bus.

FIG. 4 is a finite state machine diagram of the upload engine that is used to achieve reliable upload protocol operation.

FIG. 5 shows typical but shortened contents of the original data, ordered data, compressed data, and encrypted data for the case where the in-vehicle data comes from a CAN bus.

### DESCRIPTION OF THE INVENTION

While the ensuing description is directed to uploading in-vehicle data to the cloud, it will be appreciated that the invention is applicable to sending the in-vehicle data to other data sinks including other vehicles or the vehicle infrastructure.

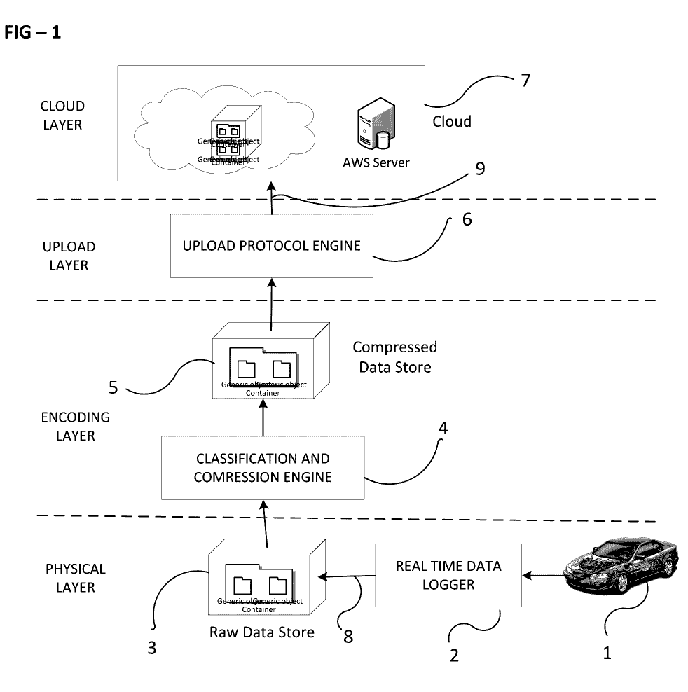

Referring to FIG. 1, a system for uploading all of in-vehicle data to the cloud is illustrated which involves a vehicle 1, a real time data logger 2, a raw data store 3, a classification and compression engine 4, a compressed data store 5, an upload protocol engine 6, and the cloud 7. The vehicle 1 is generic and could be an automobile, a truck, bus, recreational vehicle, etc. or it could be any vehicle that is capable of generating data collected by a multitude of sensors. The real time data logger can be a commercial unit or an ad hoc designed unit whose job is to collect data coming from one or more in-vehicle communication networks in a real time and time stamped fashion. The data collected by the real time data logger is temporarily or permanently stored in the raw data store 3 located inside the vehicle. The term raw data indicate that no processing of any kind is done on the collected data. The main purpose of the classification and compression engine 4 is to reduce the size of the collected data using appropriate data compression algorithms that are optimized when the data is classified appropriately. The output of the classification and compression engine is temporarily or permanently stored in the compressed data store. The upload protocol engine 6 reads data from the compressed data store and uploads the data to the cloud 7. The two required communication links are also shown in FIG. 1. The first link 8 is between the upload engine and the real-time data logger and the second link 9 is between the upload protocol engine and the cloud. FIG. 1 shows one embodiment of the cloud using the Amazon Web Services (AWS) cloud of Amazon, but the invention is independent of the cloud system, server, or vendor.

The real time data logger 2, raw data store 3, the classification and compression engine 4, the compressed data store 5, and the upload protocol engine 6 are all located inside the vehicle as this will help with the various security issues involved in the upload process.

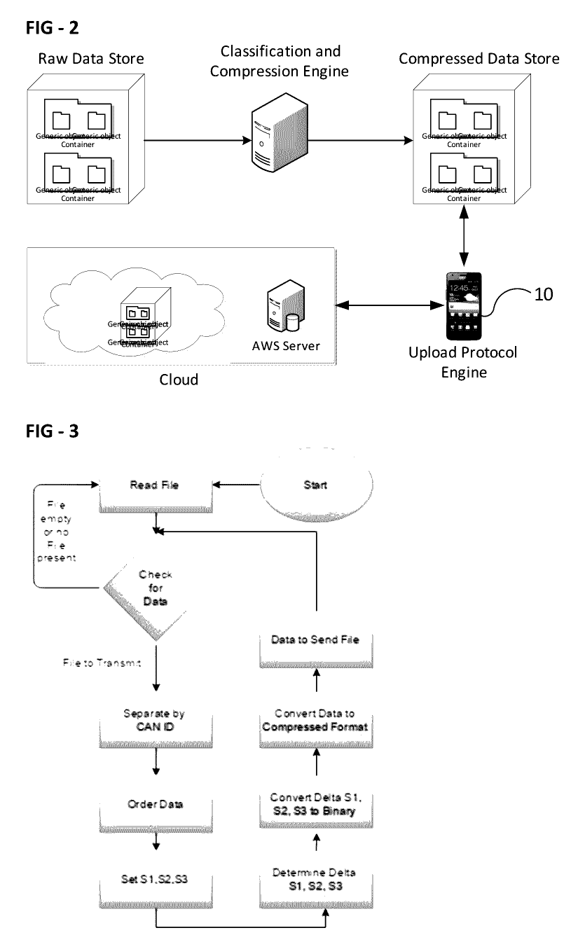

In a preferred embodiment of the invention, the upload protocol engine can be implemented in an intelligent phone 10. This is illustrated in FIG. 2 which shows a separation of the upload protocol engine and the classification and compression engine into two separate processors. In an alternative embodiment of the invention the aforementioned engines can be implemented on the same computing element. The size of the raw data to be uploaded to the cloud can be huge thus it will be appreciate the use of a compression algorithm to reduce the size of the raw data considerably so that the upload engine only uploads the compressed data. There are several data security concerns such as the confidentiality of the data and thus it will be also appreciated the use of appropriate encryption algorithms to protect the data after it leaves the vehicle and while it is stored at the cloud. The given rules for data compression leave a high degree of flexibility for compressing a wide variety of data originating from may types of sensors or directed to many actuators or other data sinks.

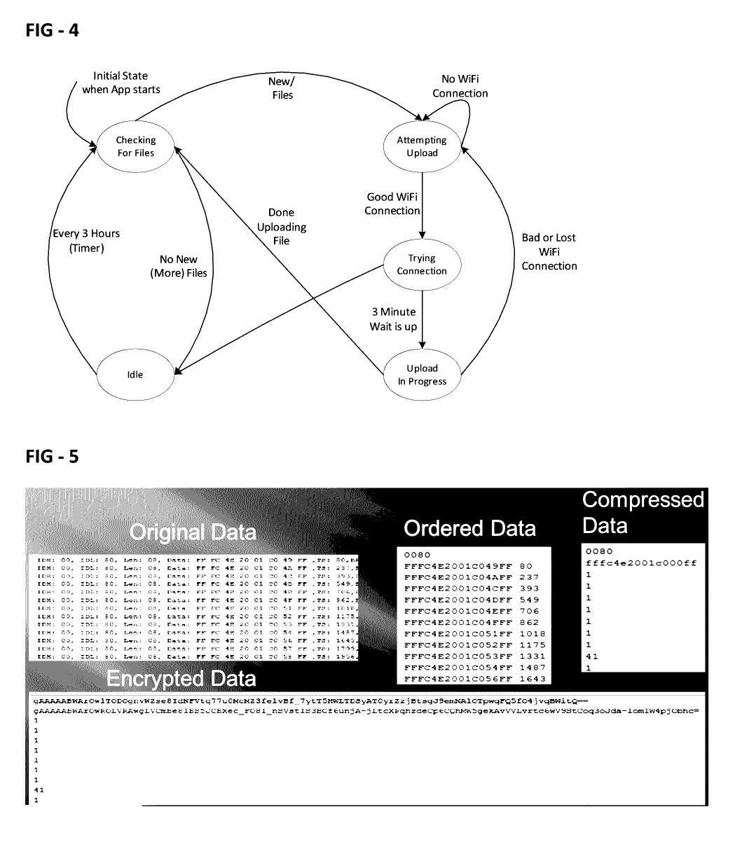

In another embodiment of the invention, the data may originate from an in-vehicle network such as the CAN bus and FIG. 3 shows a flowchart of the classification and compression algorithm for the data involving CAN identifiers (ID). it will be appreciated that the invention is also applicable to uploading data to the cloud which originates from other in-vehicle networks such as CAN-FD, LIN, FlexRay, and others. FIG. 4 shows Finite State Machine (FMS) of the cloud upload protocol that is used to endow the upload protocol engine with reliable features. The protocol can deal with no wireless connections, bad or lost connections, and recovery from faults and errors.

FIG. 5 shows the results of a specific implementation of the data classification (ordered data), data compression (compressed data), and data encryption processes (encrypted data) for one embodiment of the invention where the data originated from a CAN bus. For this particular FIG. the compression ratio was 84.22% meaning that the size of the encoded data was 15.78% of the size of the original data.

Referring to FIG. 1, the vehicle 1 is the source of data which can originate from one or more in-vehicles networks such as CAN, LIN, FlexRay, Ethernet, MOST, or others. The real-time data logger collects and logs data in a time synchronized fashion, that is, if data is collected from more than one bus, the data logging or collection is triggered by the same clock or timing event so that all of the data maintains their original temporal relationships with one another and with an absolute time reference.

The logged data is collected in the original raw format as it exists in the various in-vehicle networks and contains values of a multitude of signals that correspond to the vehicle operation that include all components of a vehicle including but not limited to engine management, powertrain, safety critical signals, and entertainment. The logged data can originate from one or more in-vehicle networks and is time stamped before it is logged or stored in permanent memory in the raw data store. The raw data is classified, compressed, and encrypted by the classification and compression engine before it is stored again in the compressed data store. The upload protocol engine then takes the compressed data and uploads it to the cloud.

It is expected that the in-vehicle data collected by the real time data logger 2 in one day is huge. To avoid problems associated with really huge files and to address reliable data upload requirements, we assume that the raw logged vehicle data is collected into a number of file segments, each segment correspond to logged data in a reasonable period, e.g., 3 hours. Thus, in this case, all of the data for a single day can have up to 8 data segments or file segments. Although all of the data for a single day can be huge, it is expected that each segment file will not be so huge. The upload method is flexible and can accommodate a wide range of data segment sizes. The following summarizes the data model used to help the upload process.

In-Vehicle data is organized in folders, each folder contains files corresponding to a single day.

A single day data can contain an number of segment files, e.g., 8 files, each segment file corresponds to logged data in a span of a few hours, e.g., 3 hours. We are using the terms “segment file” and “file segment” and “data segment” interchangeably.

Logged data corresponds to actual logged data from the native in-vehicle bus, e.g., CAN bus involving the native CAN protocol, i.e., no interpretation of upper layer protocols is performed.

The uploading protocol works on a data segment basis, with “roll back” feature in case of an unsuccessful data upload attempt. These are called “synchronization points”.

The data upload process follows the state transition diagram of FIG. 4.

Although any computing platform can be used to implement the classification and compression engine and the upload protocol engine, a laptop (or PC), or a smart phone can be used respectively in implementation of the invention. This is illustrated in FIG. 2 which shows use of components related to the invention. The raw data store contains the logged data organized by days and broken down into a number of segments that correspond to a fraction of a day, for example 3 hours. There is a separate file for each segment and this separation of data into segments is crucial for achieving reliable uploads by the upload protocol engine.

The data classification and compression engine 4 performs the following tasks on each file segment:

Data Classification.

The invention uses a compression technique described in the paper “CAN Data Reduction Using Three Segment Signal Decomposition”, by Yujing Wu, Jin-Gyun Chung, and Yinan Xu. The technique in such paper however works in real-time by encoding the difference between the current CAN data frame and the last CAN data frame collected by the logger. The invention has improved the efficiency of such an encoder by classifying and ordering the logged data by CAN identifiers and also from least changed data to most changed data in a table having the same CAN identifiers. In this way a higher compression ratio or compression efficiency than the original method was achieved. The invention has also improved the algorithm by performing a two-stage classification prior to using the core data compression algorithm. The first stage classification is by CAN identifiers and the second stage classification is to order them in increasing numerical values. Depending on the rate of change patterns, signals are combined into a set of three “super-signals” (S1, S2, and S3) which consist of one or more original signals in a way that their most significant bits change slowly and their least significant bits change more frequently. The combination of signals into super-signals depends on the size of the original data collected from the various in-vehicle networks. For example, if the original CAN data consists of 8 byte frames (i.e., 64 bits), S1, S2, and S3 can have a length of 3, 3, and 2 bytes respectively.

Data Compression.

The core data compression algorithm is similar to that in the paper “CAN Data Reduction Using Three Segment Signal Decomposition.” At the beginning of each upload period and for each CAN ID, the very first value is kept in their original values (i.e., with no compression). Subsequent values of the same CAN ID will undergo compression using a compression process detailed below. For each CAN ID, the values of the super-signals S1, S2, and S3 are compared with their last values and only their difference is encoded using a specific encoding format as in the above referenced paper. By encoding only the difference between consecutive values of a variable, a significant data compression can be achieved. The VIN and CAN identifiers are not compressed. The core compression algorithm is based on the rate of change of each signal data field. For each signal, the difference value of signals is computed (between current and preceding values). A “compression map” is then generated by placing the non-zero difference values together and only the non-zero values are retained. The compression area contains non-zero values and other information for encoding and decoding purposes. The original DLC field of a CAN frame is used to encode additional compression information and no longer indicates the length of the data field.

Data Encryption.

Data encryption is performed on a file segment basis as follows. The VIN number, the CAN ID, and the initial CAN data values are encrypted using a symmetric encryption algorithm with a strong key, e.g., Fernet encryption. Whereas the initial CAN data values are actual CAN data, the remaining data in the segment correspond to difference CAN data values. It is not necessary to encrypt the remaining of the segment since in the absence of initial (or first) CAN data values, it is not possible to recover the original data for the remaining CAN data values in the file by just having the difference values.

The program flowchart for performing the data classification and compression is illustrated in FIG. 3 where the notation S1, S2, and S3 refers to each of the signals in the paper “CAN Data Reduction Using Three Segment Signal Decomposition.” The compressed data store contains the compressed data and is organized in exactly the same fashion as that of the raw data store, i.e., it is organized by days and broken down into a number of segments that correspond to a fraction of a day, for example 3 hours. There is a separate file for each segment and this separation of data into segments is crucial for achieving reliable uploads by the upload protocol engine.

The upload protocol engine is responsible for uploading each data segment from the compressed data store to the cloud in a reliable fashion. It is assumed that a vehicle has a list of WiFi wireless access point (APs) SSIDs and associated passwords as the preferred list of APs to be used for uploading data to the cloud. If the vehicle detects a strong wireless AP signal in any of the preferred APs for a time longer than CST (connection spacing time, typically 3 minutes) it attempts the uploading process. For reliable data upload reasons, data is uploaded one data segment at a time. The main goal of the upload procedure is to upload the original data in a compressed and reliable fashion and in a way that the original data can be decoded at the cloud. This is achieved by implementing a finite state machine (FSM) illustrated in FIG. 4.

The FSM defines five states: IDLE, CHECKING FOR FILES, ATTEMPTING UPLOAD, TRYING CONNECTION, and UPLOAD IN PROGRESS. When the upload engine starts, it is in the CHECKING FOR FILES state and if there is no files or no new files since last checked then it goes to the IDLE state. However, if there are new files then it goes to the ATTEMPTING UPLOAD state where it tries to upload the segment. In this state, if there is not WiFi connections or they are very weak, then it stays in this state unless a maximum retry counter is reached in which case it goes to the IDLE state. If in the ATTEMPTING UPLOAD state, a good WiFi connection is found then it goes to an intermediary state called TRYING CONNECTION to ensure that the WiFi connection can sustain large data transfers. While in the TRYING CONNECTION, if a trial period (e.g., 3 minutes) has elapsed, then the FSM goes to the UPLOAD IN PROGRESS state indicating that a reliable connection has been found. While in the UPLOAD IN PROGRESS state, if there is a bad WiFi connection or the WiFi connection is lost, then the upload engine goes to the ATTEMPTING UPLOAD state, if however, the upload engine is finished uploading the segment then the FSM goes to the CHECKING FOR FILES state.

At the cloud, appropriate applications can be designed so that the data is unpacked, de-compressed, decrypted, and re-arranged so that the original logged data is recovered. The compressed data at the cloud contains enough information to recover the original signals collected by the various in-vehicle networks, including the original CAN IDs. This is accomplished by following the reverse procedure used for data compression and encryption. For the decryption step, since a symmetric algorithm is used, it is necessary to use the same key as that used for encryption which is assumed to be made available to the party performing the decryption in a confidential manner.

What is claimed is:

1. A method for uploading all of in-vehicle data to the cloud where such data originates from multiple in-vehicle communication networks over two communication links comprising the steps of:
establishing a first wired or wireless communication link to a real-time data logger;
establishing a second wireless communication link to the cloud;
reading the data from the real-time data logger in a way that is independent of the type of in-vehicle protocols;
reading the data from the real-time data logger in a way that is independent of the format of the in-vehicle data;
scheduling the data reading from the real-time data logger and uploading the data to the cloud in a periodic fashion

2. The method as defined in claim 1 wherein uploading the data to the cloud is in a way that is independent from the type of the two communication links external to the vehicle.

3. The method as defined in claim 1 wherein uploading the in-vehicle data to the cloud is completely un-attended including automating the entire process.

4. The method as defined in claim 1 wherein the upload process is efficient in terms of communication bandwidth utilization including using appropriate data compression algorithms.

5. The method as defined in claim 1 wherein the upload process is secure including using appropriate data encryption algorithms to protect the confidentiality nature of the data.

6. The method as defined in claim 1 wherein the upload process is reliable in operation even in the presence of various types of faults and errors in the overall process including using a state transition diagram to model various faults, error, and timing conditions.
